(19) United States
(12) Patent Application Publication
(10) Pub. No.: US 2012/0114067 A1
(43) Pub. Date: May 10, 2012

(54) EMPHASIS SIGNAL GENERATION CIRCUIT AND SIGNAL SYNTHESIS CIRCUIT

(75) Inventor: Yukito TSUNODA, Kawasaki (JP)

(73) Assignee: FUJITSU LIMITED, Kawasaki-shi (JP)

(21) Appl. No.: 13/209,885

(22) Filed: Aug. 15, 2011

(30) Foreign Application Priority Data
Nov. 8, 2010 (JP) 2010-250122

(51) Int. Cl. H04L 27/00

(52) U.S. Cl. 375/295

(57) ABSTRACT

An emphasis signal generation circuit includes a phase shifter configured to delay a signal, an adder/subtractor configured to perform addition/subtraction of a first signal and a second signal at a predetermined ratio, the ratio being freely variable, and an amplitude adjuster configured to perform adjustment of an amplitude of a signal with an adjustment amount of the amplitude being freely variable. An input signal to the emphasis signal generation circuit is input to the adder/subtractor as the first signal. Meanwhile, an emphasis component signal obtained by delaying the input signal by the phase shifter and adjusting the amplitude of the delayed input signal is input to the adder/subtractor as the second signal.

### CROSS-REFERENCE TO RELATED APPLICATION

This application is based upon and claims the benefit of priority of the prior Japanese Patent Application No. 2010-250122, filed on Nov. 8, 2010, the entire contents of which are incorporated herein by reference.

### FIELD

The embodiments discussed herein are related to a technique of signal synthesis synthesizing a plurality of signals and obtaining a synthesized signal.

### BACKGROUND

In recent years, in the field of communication, data transfer speed is becoming faster as mass data transfer has been performed by one signal with increases in the amount of data communication. Such speeding-up of data transfer may lead to a problem that it causes degradation of the data transmission signal by inter-symbol interference and the like in the cable, the board and so on.

In view of such a problem, there has been a technique to compensate for the amount of degradation of the transmission signal using an emphasis signal in which a portion in which inter-symbol interference of the signal easily occur is reinforced in advance. As a technique to generate such an emphasis signal, a technique to generate an emphasis signal by giving a delay difference between divided signals and performing addition/subtraction for them. FIG. 1A is a block diagram of an example of such an emphasis signal generation circuit.

In the emphasis signal generation circuit 10 in FIG. 1A, the input signal is divided into a first input signal that goes through the first path and a second input signal that goes through the second path. The first input signal going through the first path is subjected to buffering by a first pre-driver 12 and then input to the positive side input of an adder/subtractor 14. On the other hand, the second input signal going through the second path is given a delay time of time τ by a phase shifter 11, then subjected to buffering by a second pre-driver 13 and input to the negative side input of the adder/subtractor 14. The adder/subtractor 14 subtracts a signal in which the level of the signal input to the negative side input is multiplied by b from a signal in which the level of the signal input to the positive side input is multiplied by a, and outputs the signal as the result of the subtraction. An output driver 15 performs buffering for the signal output from the adder/subtractor 14 and outputs it.

The emphasis signal generation circuit 10 performs such signal synthesis to generate an emphasis signal from an input signal where a portion in the input signal in which inter-symbol interference of the signal easily occur is reinforced in advance.

FIG. 1B is explained here. FIG. 1B illustrates signal waveform examples of each unit of the emphasis signal generation circuit 10 in FIG. 1A, where signal waveform examples in each node of A, B and C illustrated in FIG. 1A are presented.

Referring to the example in FIG. 1B, it can be understood that the waveform of the node B is delayed by the time τ from that of the node A. This delay is given by the phase shifter 11. In addition, the signal waveform of the node C is for a signal in which a signal in which the level of signal passing through the node B is multiplied by b is subtracted from a signal in which the level of signal passing through the node A is multiplied by a. Comparing the signal waveform of the node C with that of the node A, the signal passing through the node

C has a higher level than the signal passing through the node A during the period from its rise time to the time τ, and has a lower level than the signal passing through the node A during the period from its fall time to the time τ.

The circuit in FIG. 1A generates an emphasis signal in which the absolute value of the signal is increased in the period τ immediately after rising/falling edge where inter-symbol interference easily occurs.

By the way, the degree of degradation of s signal to be compensated using the emphasis signal generated as described above individually differs depending on the length of the cable to be used, or the usage condition of the board and devices, and so on. Therefore, it is highly preferable that the generation circuit of the emphasis signal has a function to be able to freely vary the degree of the emphasis (emphasis amount) for the signal in the emphasis signal to be generated.

As a technique to make it possible to freely vary the emphasis amount of an emphasis signal to be generated, a signal synthesis circuit illustrated in FIG. 2 has been known. This circuit is a circuit that can also be used as the adder/subtractor 14 in the emphasis signal generation circuit 10 of FIG. 1A.

The signal synthesis circuit illustrated in FIG. 2 is configured to have a transistors M11, M12, M21 and M22, and resistors R11 and R12, and a variable constant current sources I11 and I21. Here, the transistors M11, M12, M21 and M22 are all n-type MOSFET (Metal Oxide Semiconductor Field Effect Transistor). In addition, the variable constant current source I11 and I12 are constant current sources that can freely vary the setting of the current value that it feeds.

In FIG. 2, one of the terminals of the resistor R11 is connected to the drain terminal of each of transistors M11 and M21, and one of the terminals of the resistor R12 is connected to the drain terminal of the each of transistors M12 and M22. The other terminals of the resistors R11 and R12 are both connected to a power supply VSS through the variable constant current source I11, and the source terminal of each of the transistors M11 and M12 is connected to the power supply VSS through the variable constant current source I21.

Terminals IN1P and IN1N to which a signal A being the first differential signal input to the circuit in FIG. 2 is input are connected to the gate terminals of the transistors M22 and M21, respectively. Meanwhile, terminals IN2P and IN2N to which a signal B being the second differential signal input to the circuit in FIG. 2 is input are connected to the gate terminals of the transistors M11 and M12, respectively. Then, terminals QUIP and OUTN from which a signal C being the differential signal of the output of the circuit are connected to the node of the resistor R12 and the transistors M12 and M22, and the node of the resistor R11 and the transistors M11 and M12, respectively.

In the circuit in FIG. 2, when the current value of the variable constant current source I21 is set to a and the current value of the variable constant current source I11 is set to b, the relationship between the output signal C and the input signals A and B is expressed by the following expression.

C=a×A−b×B

Here, the current value a of the variable constant current source I21 and the current value b of the variable constant current source I11 are both freely variable. Therefore, by using the signal synthesis circuit in FIG. 2 as the adder/subtractor 14 in the emphasis signal generation circuit 10 in FIG. 1A, the emphasis amount of the emphasis signal to be generated can be freely variable.

When configuration the emphasis signal generation circuit 10 in FIG. 1A using the signal synthesis circuit in FIG. 2 as the adder/subtractor 14, the level of the input signal B needs to be set to a magnitude corresponding to the largest case in the usage range of the expected emphasis amount. This setting is maintained even when emphasis is not to be performed or when the emphasis amount is set to be very small, resulting in large power consumption in such cases.

Meanwhile, a technique described in the following document has been known.

Document 1:

Japanese Laid-open Patent Publication No. 2004-88693

### SUMMARY

According to an aspect of the embodiment, an emphasis signal generation circuit includes: a phase shifter configured to delay a signal; an adder/subtractor configured to perform addition/subtraction of a first signal and a second signal at a predetermined ratio, the ratio being freely variable; and an amplitude adjuster configured to perform adjustment of an amplitude of a signal with an adjustment amount of the amplitude being freely variable, wherein an input signal is input to the adder/subtractor as the first signal, and an emphasis component signal obtained by delaying the input signal by the phase shifter and adjusting an amplitude of the delayed input signal by the amplitude adjuster is input to the adder/subtractor as the second signal.

According to another aspect of the embodiment, an emphasis signal generation circuit includes: a phase shifter configured to delay a signal; an adder/subtractor configured to perform addition/subtraction of a first signal and a second signal at a predetermined ratio, the ratio being freely variable; an amplitude adjuster configured to perform adjustment of an amplitude of a signal; a direct voltage generator configured to generate a direct voltage equal to a level of a direct voltage component included in a signal output from the amplitude adjuster; and a switch configured to switch whether or not to generate an emphasis signal, wherein an input signal is input to the adder/subtractor as the first signal, and when the switch is switched to a side for generating the emphasis signal, an emphasis component signal obtained by delaying the input signal by the phase shifter and adjusting an amplitude of the delayed input signal by the amplitude adjuster is input to the adder/subtractor as the second signal, and when the switch is switched to a side for not generating the emphasis signal, a direct voltage generated by the direct voltage generator is input to the adder/subtractor as the second signal.

According to yet another aspect of the embodiment, a signal synthesis circuit includes: an adder/subtractor configured to perform addition/subtraction of a first signal and a second signal at a predetermined ratio, the ratio being freely variable; an amplitude adjuster configured to perform adjustment of a signal; and a direct voltage level adjuster configured to adjust a level of a direct voltage component of a signal input to the adder/subtractor, wherein a first input signal is input to the adder/subtractor as the first signal, and a second input signal is subjected to adjustment of an amplitude by the amplitude adjuster and adjustment of a level of a direct voltage component by the direct voltage level adjuster and then input to the adder/subtractor as the second signal.

According to yet another aspect of the embodiment, a signal synthesis circuit comprising: an adder/subtractor configured to perform addition/subtraction of a first signal and a second signal at a predetermined ratio, the ratio being freely variable; an amplitude adjuster configured to perform adjustment of a signal; a direct voltage generator configured to generate a direct voltage equal to a level of a direct voltage component included in a signal output from the amplitude adjuster; and a switch configured to switch whether or not to generate a synthesis signal, wherein a first input signal is input to the adder/subtractor as the first signal, and when the switch is switched to a side for generating the synthesis signal, a second input signal is subjected to adjustment of amplitude by the amplitude adjuster and then input to the adder/subtractor as the second signal, and when the switch is switched to a side for not generating the synthesis signal, a direct voltage generated by the direct voltage generator is input to the adder/subtractor as the second signal.

The object and advantages of the embodiment will be realized and attained by means of the elements and combinations particularly pointed out in the claims.

It is to be understood that both the foregoing general description and the following detailed description are exemplary and explanatory and are not restrictive of the embodiment, as claimed.

### BRIEF DESCRIPTION OF DRAWINGS

FIG. 1A is a block diagram of an example of an emphasis signal generation circuit;

FIG. 1B is signal waveform examples of each part of the emphasis signal in FIG. 1A;

FIG. 2 is an example of the configuration of a conventional signal synthesis circuit;

FIG. 3 is a configuration diagram of an example of a signal synthesis circuit;

FIG. 4 is a block diagram of an example of an emphasis signal generation circuit;

FIG. 5 is a configuration diagram of another example of a signal synthesis circuit;

FIG. 6 is a block diagram of another example of an emphasis signal generation circuit; and

FIG. 7 is a configuration diagram of yet another example of a signal synthesis circuit.

### DESCRIPTION OF EMBODIMENTS

Preferred embodiments of the present invention will be explained with reference to accompanying drawings.

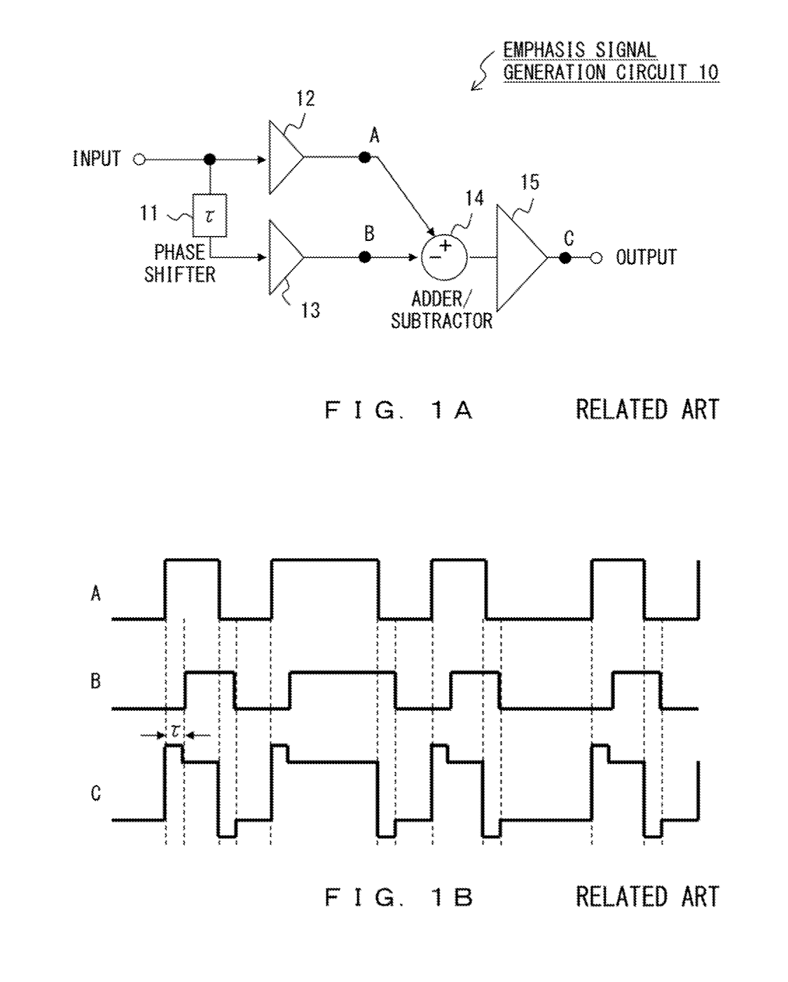

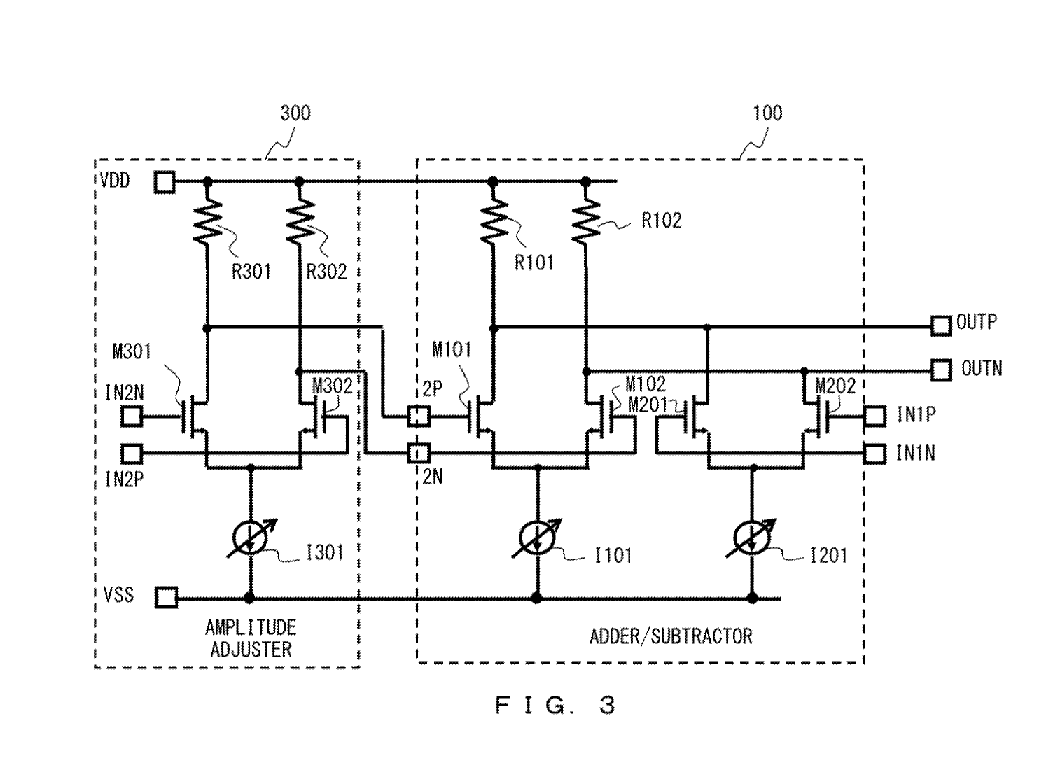

FIG. 3 is a configuration diagram of an example of a signal synthesis circuit. This signal synthesis circuit is a circuit that can be used in a part of the configuration of the emphasis signal generation circuit in FIG. 1A.

The signal synthesis circuit in FIG. 3 is configured to have an adder/subtractor 100 and an amplitude adjuster 300.

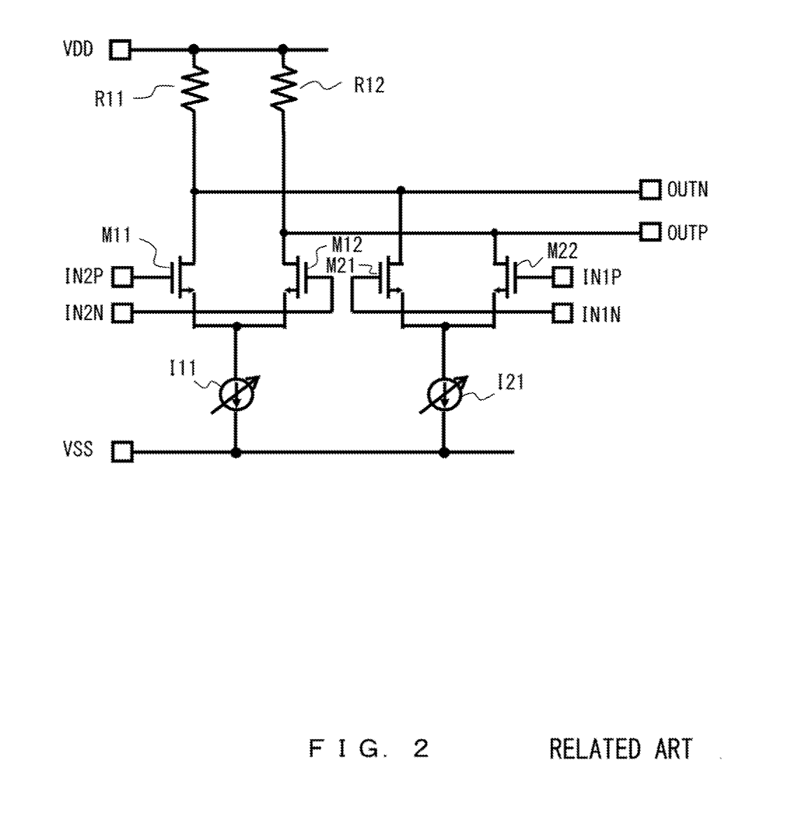

The adder/subtractor 100 has a similar configuration as that in the signal synthesis circuit whose configuration is illustrated in FIG. 2, and is configured to have transistors M101, M102, M201 and M202, resistors R101 and R102, variable constant current sources I101 and I201. Here, the transistors M101, M102, M201 and M202 are all n-type MOSFET. Meanwhile, the variable constant current sources I101 and I201 are constant variable sources that can freely vary the setting the current value to be fed.

In FIG. 3, one of the terminals of the resistor R101 is connected to the drain of each of the transistors M101 and M201, and one of the terminals of the resistor R102 is connected to the drain of each of the transistors M102 and M202. The other terminals of the resistors R101 and R102 are both connected to a power supply VDD. The source terminal of each of the transistors M101 and M102 is connected to a power supply VSS through the variable constant current source I101, and the source terminal of each of the transistors M201 and M202 is connected to the power supply VSS through the variable constant current source I201.

Terminals IN1P and IN1N to which a first signal A being a differential signal input to the adder/subtractor 100 are connected to the gate terminal of the transistors M202 and M201, respectively. Meanwhile, to the terminals IN1P and IN1N, a first input signal input to the signal synthesis circuit in FIG. 3 is input.

Terminals 2P and 2N to which a second signal B being another differential signal input to the adder/subtractor 100 are connected to the gate terminal of the transistors M102 and M102, respectively. Meanwhile, to the terminals 2P and 2N, a differential signal output from the amplitude adjuster 300 is input.

Then, terminals OUTP and OUTN to from which a differential signal C being the output of the adder/subtractor 100 are connected to the node of the resistors R102 and the transistors M102 and M202, and the node of the resistor R101 and transistors M101 and M201, respectively. The signal output from the terminals OUTP and OUTN is an output signal of the signal synthesis circuit in FIG. 3.

In the adder/subtractor 100 in FIG. 3, when the current value of the variable constant current source I201 is set to a and the current value of the variable constant current source I101 is set to b, the relationship between the output signal C and the input signals A and B being the output of the adder/subtractor 100 is expressed by the following expression.

C=a×A−b×B

Here, the current value of the variable constant current source I201 and the current value b of the variable constant current source I101 are both freely variable. That is, the adder/subtractor 100 is a circuit that performs addition/subtraction of the first signal A and the second signal B with a predetermined ratio of a:b, and furthermore, the ratio a:b is freely variable.

The adder/subtractor 100 is configured as described above.

Next, the amplitude adjuster 300 is explained.

The amplitude adjuster 300 has transistors M301 and M302, resistors R301 and R302 and a variable constant current source I301, which constitute a differential amplifier circuit.

The transistors M301 and M302 are both n-type MOSFET and are a pair of transistors that constitute a differential pair.

The resistors R301 and R302 are inserted between the drain terminal of each of the transistors M301 and M302, and the power supply VDD. The resistors R301 and R302 function as a load resistor of the differential amplifier circuit.

The variable constant current source I301 is a tail current source for the differential pair constituted by the transistors M301 and M302, and is a constant current source that can freely vary the setting of the current value to be fed.

To the gate terminal of the each of the transistors M302 and M301, the terminals IN2P and IN2N are connected. To the terminals IN2P and IN2N, a differential signal being the input signal to the amplitude adjuster 300 is input. Then, the terminals 2P and 2N from which a differential signal being the output of the amplitude adjuster 300 is output are connected to the node of the resistor R301 and the transistor M301, and the node of the resistor R302 and the transistor M302. The signal output from the terminals 2P and 2N is input to the adder/subtractor 100 as the second signal B mentioned above.

The amplitude adjuster 300 is configured as described above, to constitute a differential amplifier circuit. Therefore, the amplitude adjuster 300 amplifies a signal input to the terminals IN2P and IN2N, and outputs from the terminals 2P and 2N. Here, the variable constant current source I301 is a tail current source for the differential pair constituted by the transistors M301 and M302, therefore, the variable constant current source I301 is capable of varying the degree of amplification of a signal in the differential amplifier circuit by changing the setting of the current value. Therefore, the amplitude adjuster 300 can perform adjustment of the amplitude of a signal output from terminals 2P and 2N, by changing the setting of the current value of the variable constant current source I301.

The signal synthesis circuit in FIG. 3 is configured as described above.

Meanwhile, when using the signal synthesis circuit in apart of the configuration of the emphasis signal generation circuit 10 in FIG. 1A, the adder/subtractor 100 in FIG. 3 is to be the adder/subtractor 14 in FIG. 1, and the amplitude adjuster 300 in FIG. 3 is to be the second pre-driver 13 in FIG. 1. That is, a phase shifter 11 that delays the signal is provided in the prior stage of the amplification adjuster 300 in FIG. 3 to delay an input signal in the phase shifter 11, and adjustment of its amplitude is performed by the amplitude adjuster 300 to generate an emphasis component signal. Then, the input signal is input to the adder/subtractor 100 as the first signal A, and the generated emphasis component signal is input to the second signal B.

When the signal synthesis circuit in FIG. 3 is used in apart of the configuration of the emphasis signal generation circuit in FIG. 1A, an emphasis signal is output as an output signal of the adder/subtractor 100. Furthermore, since the current value of the variable constant current source I201 and the variable constant current source I101 b is freely variable, the emphasis amount of the emphasis signal to be generated can be varied.

By using the amplification adjuster 300 as the second pre-driver 13, in a case in which emphasis is not performed or the emphasis amount is very small, the power consumption in the amplitude adjuster 300 can be an amount in line with the emphasis amount. Therefore, waste of power consumption in such cases is reduced.

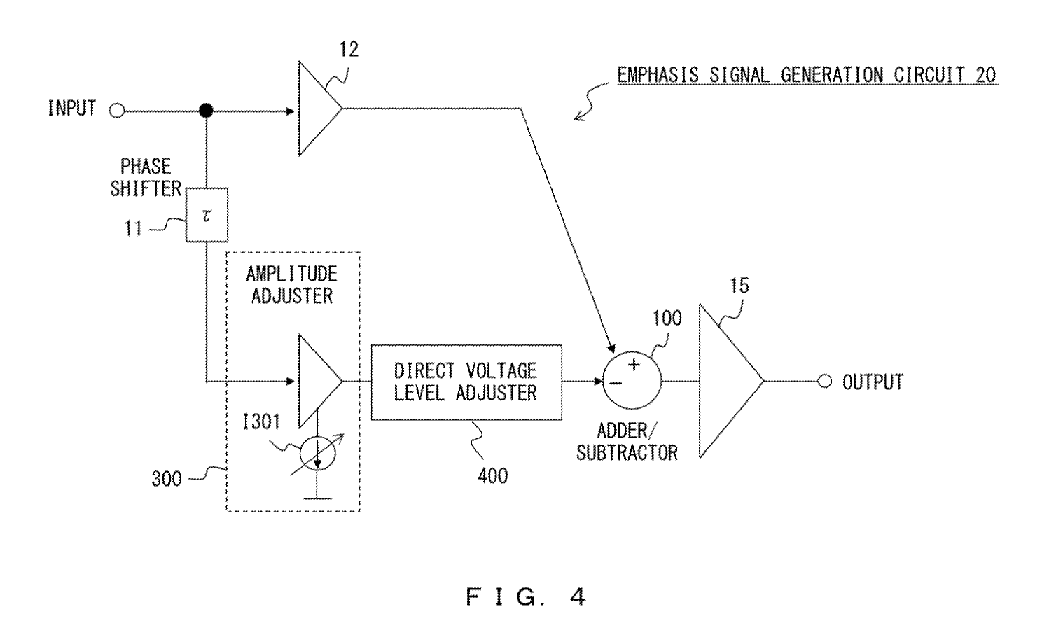

Next, FIG. 4 is explained. FIG. 4 is a block diagram of an example of an emphasis signal generation circuit.

In the case in which the emphasis signal generation circuit 10 in FIG. 1A is composed using the signal synthesis circuit illustrated in FIG. 3, when the current value of the variable constant current source I301 is changed, the emphasis amount of the generated emphasis signal changes. However, when the current value of the variable constant current source I301 is changed, the level of the direct voltage component of the emphasis component signal input to the adder/subtractor 100 output from the amplitude adjuster 300 also changes. The fluctuation in the level may affect the addition/subtraction of the first signal A and the second signal B in the adder/subtractor 100.

Then, in an emphasis signal generation circuit 20, influence on the addition/subtraction in the adder/subtractor 100 is suppressed by making the level of the direct voltage component of the emphasis component signal input to the adder/subtractor 100 a constant value.

The emphasis signal generation circuit 20 in FIG. 4 is configured to have a phase shifter 11, a first pre-driver 12, an output driver 15, an adder/subtractor 100, an amplitude adjuster 300 and a direct voltage level adjuster 400. Among then, the phase shifter 11, the first pre-driver 12, and the output driver 15 are the same as those in the emphasis signal generation circuit 10 in FIG. 1A. In addition, the configuration of the adder/subtractor 100 and the amplitude adjuster 300 is the same as that in the signal emphasis circuit in FIG. 3.

In the emphasis signal generation circuit 20 in FIG. 4, an input signal is divided into a first input signal that passes through a first path and a second input signal that passes through a second path.

The first input signal that passes through the first path is subjected to buffering by the first pre-driver 12 and then input to the positive-side input of the adder/subtractor 100. Meanwhile, the second input signal that passes through the second path is input to the phase shifter 11.

The phase shifter 11 delays the input second input signal by a predetermined time t and outputs it.

The amplitude adjuster 300 adjusts the amplitude of a signal output from the phase shifter 11, and its adjustment amount of the amplitude is freely variable. The signal output from the amplitude adjuster 300 is an emphasis component signal.

The direct voltage level adjuster 400 adjusts the level of the direct voltage component of the emphasis signal output from the amplitude adjuster 300 and input to the adder/subtractor 100. This adjustment is performed by changing the setting of the variable constant current source I301.

The adder/subtractor 100 performs addition/subtraction of a signal output from the first pre-driver 12 (the first signal A mentioned above) and an emphasis component signal output from the amplitude adjuster 300 (the second signal B mentioned above) with a predetermined ratio. Meanwhile, with the adder/subtractor 100, the ratio in the addition/subtraction is freely variable. However, the emphasis component signal is input to the adder/subtractor 100 after the level of its direct component is adjusted by the direct voltage level adjuster 400.

The output driver 15 performs buffering for an emphasis signal output from the addition/subtraction 14 and outputs it.

As described above, in the emphasis signal generation circuit 20 in FIG. 4, the level of the direct voltage component of the emphasis signal input to be input to the adder/subtractor is adjusted by the direct voltage level adjuster 400 and is input to the adder/subtractor 100. Therefore, influence on the addition/subtraction in the adder/subtractor 100 due to fluctuation in the level is suppressed.

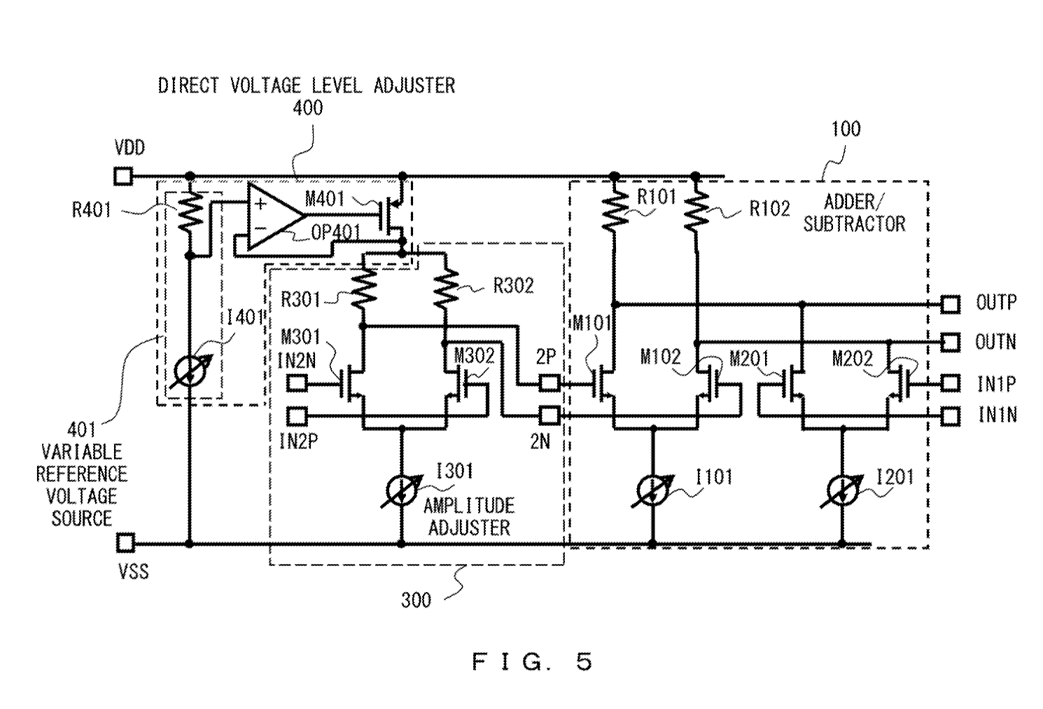

Next, FIG. 5 is explained. FIG. 5 is a configuration diagram of another example of a signal synthesis circuit. The signal synthesis circuit can be used in a part of the configuration of the emphasis signal generation circuit 20 in FIG. 4.

The signal synthesis circuit in FIG. 5 is configured to have an adder/subtractor 100, an amplitude adjuster 300, and a direct voltage level adjuster 400. Among them, the adder/subtractor 100 and the amplitude adjuster 300 are the same as those in the signal synthesis circuit illustrated in FIG. 3, so explanation for them is omitted here, and the configuration of the direct voltage level adjuster 400 is explained.

In FIG. 5, the direct voltage level adjuster 400 is configured to have variable constant current source I401, a resistor R401, a transistor M401 and an operational amplifier OP401.

The variable constant current source I401 is a current source that determines the current to be fed to the resistor R401, and is a constant current source that can freely vary the setting of the current value to be fed.

The resistor R401 is inserted between the power supply VDD and the variable constant current source I401. Therefore, the potential of the node of the resistor R401 and the variable constant current source I401 is a potential that is always lower than the power supply VDD by the amount of voltage decrease occurring from the current fed by the variable constant current source I401 to the resistor R401. In addition, the potential can be freely varied by changing the setting of the current value to be fed by the variable constant current source I401. That is, the variable constant current source I401 and the resistor R401 constitutes a variable reference voltage source 401 being a voltage source that generates a predetermined reference voltage value and that can freely vary the reference voltage value.

The transistor M401 is a p-type MOSFET, and its source terminal is connected to the power supply VDD. Meanwhile, the drain terminal of one of terminals (the side to which the power supply VDD is connected in FIG. 3) of resistors R301 and R302 being load resistors in the differential amplifier circuit formed in the amplitude adjuster 300. That is, the transistor M401 is inserted at the connection point of the power supply of the signal synthesis circuit and the differential amplifier circuit formed in the amplitude adjuster 300. The transistor M401 performs control of the current that the power supply of the signal synthesis circuit feeds to the differential amplifier circuit formed in the amplitude adjuster 300.

The operational amplifier OP401 is a comparator that perform comparison of the size of the values of the reference voltage value generate by the variable reference voltage source 401 mentioned above and the voltage values of the node of the transistor M401 and the resistors R301 and R302. The output of the operational amplifier OP401 is connected to the gate terminal of the transistor M401, and the gate voltage is changed according to the comparison of the comparison of the size described above.

The transistor M401 is a voltage adjuster that controls the drain-source voltage in accordance with the change of the gate voltage to match the voltage value of the node of the transistor M401 and the resistors R301 and R302 with the reference voltage value generated by the variable reference voltage source 401. That is, the transistor M401 changes the voltage fed by the power supply to the differential amplifier circuit of the amplitude adjuster 300 in accordance with the comparison result of the operational amplifier OP401, and matches the voltage value applied to the differential amplification circuit to the reference voltage value generated by the variable reference voltage source 401.

Here, as described above, the variable reference voltage source 401 formed by the variable constant current source I401 and the resistor R401 is capable of changing the reference voltage value by changing the current value fed by the variable constant current source I401. Therefore, the direct voltage level adjuster 400 in FIG. 5 is capable of changing the voltage value flowing in the differential amplifier circuit formed in the amplitude adjuster 300 by changing the reference voltage value.

When the voltage value flowing in the differential amplification circuit is changed, the level of the direct voltage component included in the output signal of the differential amplification circuit changes. Therefore, when the amplitude of the emphasis component signal is adjusted by changing the current value of the variable constant current source I301 to change the emphasis amount of the emphasis signal to be generated, the setting of the current value fed by the variable constant current source I401 is appropriately changed in accordance with the adjustment. By doing so, even when the amplitude of the emphasis component signal is changed, the level of its direct component can be maintained at a constant value always regardless of the change. Therefore, influence on the addition/subtraction in the adder/subtractor 100 is suppressed.

Meanwhile, in the signal synthesis circuit in FIG. 5, the transistor M401 that controls the voltage value in the differential amplifier circuit formed in the amplification adjuster 300 is inserted at the connection point of the power supply of the signal synthesis circuit and the differential amplifier circuit formed in the amplitude adjustment circuit 300. The inserting position is a position grounded in terms of high frequency wave, so it is preferable to perform the control of the voltage value in the differential amplification circuit at this inserting position, in that it does not affect the characteristics of a high-speed signal.

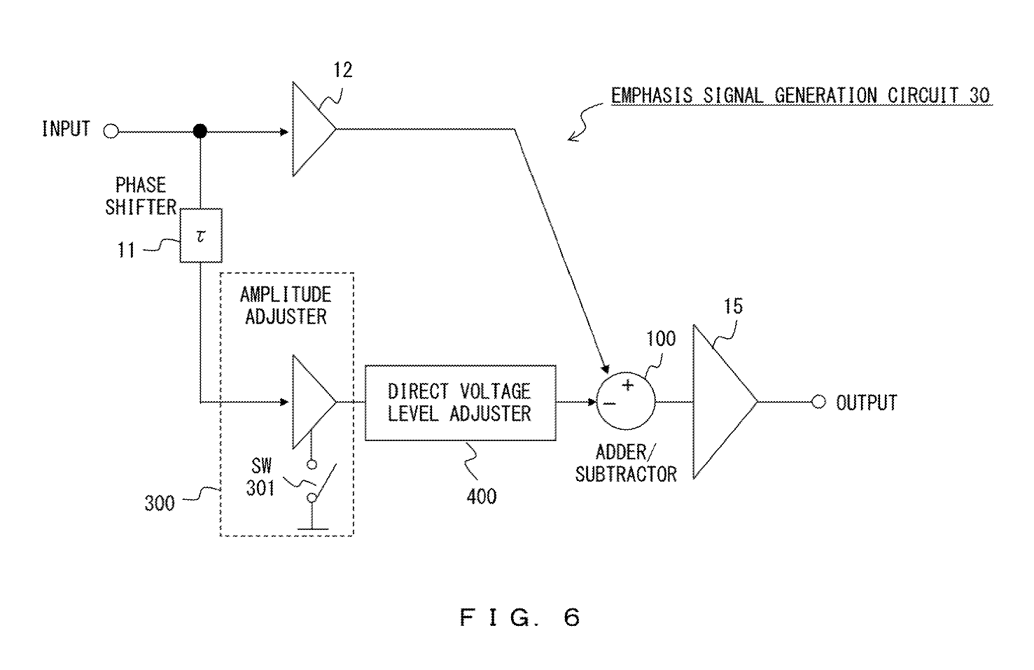

Next, FIG. 6 is explained. FIG. 6 is a block diagram of an example of an emphasis signal generation circuit.

An emphasis signal generation circuit 30 in FIG. 6 is configured to have a phase shifter 11, a first pre-driver 12, an output driver 15, an adder/subtractor 100, an amplitude adjuster 300 and a direct voltage level adjuster 400, in the same manner as the emphasis signal generation circuit 20 illustrated in FIG. 4.

In the circuit in FIG. 6, whether or not to perform emphasis of the input signal can be switched according to the status of a switch SW 301 of the amplitude adjuster 300. In this regard, the circuit in FIG. 6 is different from the circuit in FIG. 4 that is capable of freely varying the emphasis amount of the emphasis signal generated in accordance with the change of the setting of the variable constant current source I301. In addition, with this difference, as described later, the detailed configuration of the direct level adjuster 400 in the circuit in FIG. 6 is different from that in the circuit in FIG. 4. Therefore, these differences are mainly explained here, and detailed explanation for other constituent elements is omitted.

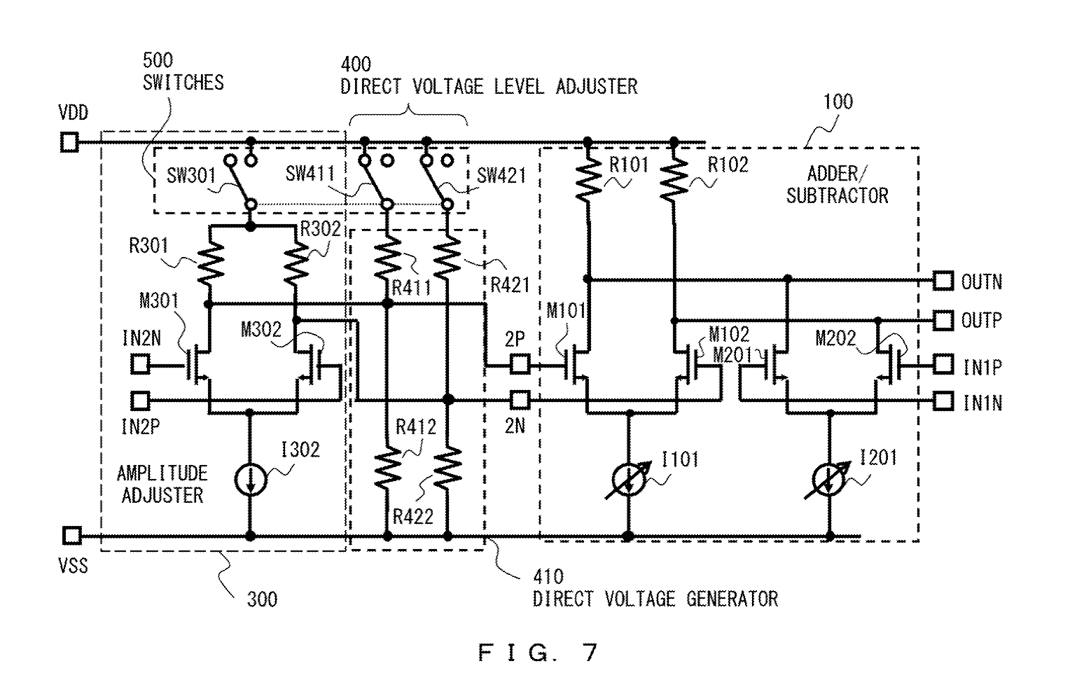

Next, FIG. 7 is explained. FIG. 7 is a configuration diagram of yet another example of a signal synthesis circuit. This signal synthesis circuit is a circuit that can be used in a part of the configuration of the emphasis signal generation circuit 30 in FIG. 6.

The signal synthesis circuit in FIG. 7 is configured to have an adder/subtractor 100, an amplitude adjuster 300, and a direct voltage level adjuster 400. Among them, the adder/subtractor 100 is the same as that in the signal synthesis circuit illustrated in FIG. 3, so explanation for it is omitted here.

The amplitude adjuster 300 has transistors M301 and M302, resistors R301 and R302, and a constant current source I302 that are the same as those in FIG. 3, which constitute a differential amplifier circuit that is the same as that in FIG. 3. Detailed explanation of the configuration of the differential amplifier circuit is omitted. However, in the configuration in FIG. 3, the variable constant current source I301 being a tail current source for the differential pair formed by the transistor M301 and M302 is replacedby the constant current source I302 in the configuration in FIG. 7. For this reason, in the amplitude adjuster 300, the adjustment amount of the amplitude of the signal is not freely variable as that in FIG. 5 but is fixed.

In the signal synthesis circuit in FIG. 7, the amplitude adjuster 300 further has a switch SW301 being one of constituent elements of switches 500.

The switch SW301 is inserted between the power supply VDD and one end (the side to which the power supply VDD is connected in FIG. 3) of the resistors R301 and R302 being load resistors in the differential amplifier circuit formed in the amplitude adjuster 300. The switch SW301 switches whether or not to generate an emphasis signal being a synthesized signal obtained by signal synthesis by the signal synthesis circuit. Here, when the emphasis signal is to be generated, the switch SW301 is switched to the closed state, and when the emphasis signal is not to be generated, the switch SW301 is switched to the opened state. When the switch SW301 is switched to the closed state being the one for generating the emphasis signal, power is supplied from the power supply to the differential amplifier circuit, the amplitude of the signal input to the terminals IN2P and IN2N is adjusted, and an emphasis component signal is output from the terminals 2P and 2N. On the other hand, when the switch SW301 is switched to the opened state being the one for not generating the emphasis signal, as a result of power supply from the power supply to the differential amplification unit being cut off, the operation of the differential amplifier circuit is stopped, and waste of power consumption by the differential amplifier circuit is reduced.

Next, the configuration of the direct voltage level adjuster 400 in the signal synthesis circuit in FIG. 7 is explained.

The voltage level adjustment 400 has switches SW411 and SW421 being constituent elements of the switches 500, and resistors R411, R412, R421 and R422 being constituent elements of a direct voltage generator 410.

The switch SW411 is inserted between the power supply VDD and one end of the resistor R411. The resistor R412 is connected serially to another end of the resistor R411, and another end of the resistor R412 is connected to the power supply VSS. In addition, the switch SW421 is inserted between the power supply VDD and one end of the resistor R421. The resistor R422 is connected serially to another end of the resistor R421, and another end of the resistor R422 is connected to the power supply VSS.

Meanwhile, the node of the resistor R411 and the resistor R412 that are connected serially is connected to the terminal 2P being one of the output terminals of the amplitude adjuster 300. In addition, the node of the resistor R411 and the resistor R412 that are connected serially is connected to the terminal 2N being the other one of the output terminals of the amplitude adjuster 300.

The switches SW411 and SW421 are switched in tandem with the switch SW301 that switches whether or not to generate an emphasis signal being a synthesized signal obtained by signal synthesis of the signal synthesis circuit. However, the switches SW411 and SW421 are switched to the opened state when the emphasis signal is to be generated, and switched to the closed state when the emphasis signal is not to be generated.

When the switches SW411 and SW421 are switched to the opened state being the one for generating the emphasis signal, the emphasis component signal being an output signal of the differential amplifier circuit formed in the amplitude adjuster 300 is output from the terminals 2P and 2N. Therefore, in this case, the emphasis component signal is input to the adder/subtractor 100 as the second signal B.

On the other hand, when the switches SW411 and SW421 are switched to the closed state being the one for not generating the emphasis signal, a voltage obtained by dividing the difference in the potentials of the power supply VDD and the power supply VSS by the resistors R411 and R412 is output from the terminal 2P. In addition, in this case, a voltage obtained by dividing the difference in the potentials of the power supply VDD and the power supply VSS by the resistors R421 and R422 is output from the terminal 2N. Therefore, in this case, the direct voltage generated as described above by the direct voltage generator 410 is input to the adder/subtractor 100 as the second signal B.

Here, so as to make the voltage obtained by voltage dividing by the resistors R411 and R412 and by voltage dividing by the resistors R421 and 422 equal to the level of the direct voltage component included in the emphasis component signal output from the amplitude adjuster 300, the resistance values of them are set. By setting the resistance values of the resistors R411, R412, R421 ad R422, even if switching of whether or not to generate the emphasis signal is performed, the level of the direct voltage component of a signal input to the adder/subtractor 100 is maintained at a constant value. Therefore, influence on the operation of the adder/subtractor 100 is suppressed.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An emphasis signal generation circuit comprising:
a phase shifter configured to delay a signal;
an adder/subtractor configured to perform addition/subtraction of a first signal and a second signal at a predetermined ratio, the ratio being freely variable; and
an amplitude adjuster configured to perform adjustment of an amplitude of a signal with an adjustment amount of the amplitude being freely variable, wherein
an input signal is input to the adder/subtractor as the first signal, and
an emphasis component signal obtained by delaying the input signal by the phase shifter and adjusting an amplitude of the delayed input signal by the amplitude adjuster is input to the adder/subtractor as the second signal.

2. The emphasis signal generation circuit according to claim 1, further comprising
a direct voltage level adjuster configured to adjust a level of a direct voltage component of a signal input to the adder/subtractor, wherein
the level of the direct voltage component of an emphasis component signal is adjusted by the direct voltage level adjuster, and the emphasis signal component with the level of the direct voltage component having been adjusted by the direct voltage component level adjuster is input to the adder/subtractor as the second signal.

3. The emphasis signal generation circuit according to claim 2, wherein
the amplitude adjuster is configured to include a differential amplifier circuit, and
the direct voltage level adjuster adjusts the level of the direct voltage component of an emphasis signal input to the adder/subtractor depending on changing a current value flowing from a power supply to the differential amplifier circuit.

4. The emphasis signal generation circuit according to claim 3, wherein
the direct voltage level adjuster includes:
a variable reference voltage source configured to generate a predetermined reference voltage, the reference voltage being freely variable;
a comparator configured to perform comparison of a size of a reference voltage value generated by the variable reference voltage source and a size of a voltage value applied to the differential amplifier; and
a voltage adjuster configured to change a voltage value supplying the power to the differential amplifier according to a comparison results of the comparator to match the voltage value applied to the differential amplifier with the reference voltage value generated by the variable reference voltage source to adjust a voltage value input to the adder/subtractor from the differential amplifier to keep the adder/subtractor as the operating condition, and
the direct voltage level adjuster changes the voltage value output from the differential amplifier circuit depending on changing the setting of tail current source for the differential pair with a current value being freely variable.

5. The emphasis signal generation circuit according to claim 4, wherein
the voltage adjuster is inserted at a connection point of the power supply and the differential amplifier.

6. The emphasis signal generation circuit according to claim 3, wherein
the differential amplifier includes:
a pair of transistors forming a differential pair;
load resistors connected to a drain terminal of each of the pair of transistors; and
a constant current source being a tail current source for the differential pair with a current value being freely variable, and
the amplitude adjuster performs the adjustment of the amplitude by changing a setting of a current value at the variable constant current source.

7. An emphasis signal generation circuit comprising:
a phase shifter configured to delay a signal;
an adder/subtractor configured to perform addition/subtraction of a first signal and a second signal at a predetermined ratio, the ratio being freely variable;
an amplitude adjuster configured to perform adjustment of an amplitude of a signal;
a direct voltage generator configured to generate a direct voltage equal to a level of a direct voltage component included in a signal output from the amplitude adjuster; and
a switch configured to switch whether or not to generate an emphasis signal, wherein
an input signal is input to the adder/subtractor as the first signal, and
when the switch is switched to a side for generating the emphasis signal, an emphasis component signal obtained by delaying the input signal by the phase shifter and adjusting an amplitude of the delayed input signal by the amplitude adjuster is input to the adder/subtractor as the second signal, and when the switch is switched to a side for not generating the emphasis signal, a direct voltage generated by the direct voltage generator is input to the adder/subtractor as the second signal.

8. The emphasis signal generation circuit according to claim 7, wherein
the amplitude adjuster is configured using a differential amplifier circuit, and
when the switch is switched to a side for generating the emphasis signal, supply of power to the differential amplifier circuit is performed, and when the switch is switched to a side for not generating the emphasis signal, supply of power to the differential amplifier circuit is cut off.

9. The emphasis circuit generation circuit according to claim 8, wherein
the differential amplifier circuit includes:
a pair of transistors forming a differential pair;
load resistors connected to a drain terminal of each of the pair of transistors; and
a constant current source being a tail current source for the differential pair.

10. The emphasis signal generation circuit according to claim 7, wherein
the direct voltage generator includes serially-connected resistor elements configured to generate a direct voltage equal to a level of a direct voltage component included in a signal output by the amplitude adjuster by dividing a power supply voltage.

11. A signal synthesis circuit comprising:
an adder/subtractor configured to perform addition/subtraction of a first signal and a second signal at a predetermined ratio, the ratio being freely variable;
an amplitude adjuster configured to perform adjustment of a signal; and
a direct voltage level adjuster configured to adjust a level of a direct voltage component of a signal input to the adder/subtractor, wherein
a first input signal is input to the adder/subtractor as the first signal, and
a second input signal is subjected to adjustment of an amplitude by the amplitude adjuster and adjustment of a level of a direct voltage component by the direct voltage level adjuster and then input to the adder/subtractor as the second signal.

12. The signal synthesis circuit according claim 11, wherein
the amplitude adjuster is configured to include a differential amplifier circuit, and
the direct voltage level adjuster adjusts the level of the direct voltage component of the signal input to the adder/subtractor as the second signal by changing a current value flowing from a power supply to the differential amplifier circuit.

13. The signal synthesis circuit according claim 12, wherein
the direct voltage level adjuster includes:
a variable reference voltage source configured to generate a predetermined reference voltage, the reference voltage being freely variable;
a comparator configured to perform comparison of a size of a reference voltage value generated by the variable reference voltage source and a size of a voltage value applied to the differential amplifier circuit; and
a voltage adjuster configured to change a current value flowing from the power supply to the differential amplifier circuit according to a comparison results of the comparator to match the voltage value applied to the differential amplifier circuit with the reference voltage value generated by the variable reference voltage source, and
the direct voltage level adjuster changes the voltage value output from the differential amplifier circuit by changing the setting of the reference voltage value at the variable reference voltage source.

14. The signal synthesis circuit according to claim 13, wherein
the voltage adjuster is inserted at a connection point of the power supply and the differential amplifier circuit.

15. A signal synthesis circuit comprising:
an adder/subtractor configured to perform addition/subtraction of a first signal and a second signal at a predetermined ratio, the ratio being freely variable;
an amplitude adjuster configured to perform adjustment of a signal;
a direct voltage generator configured to generate a direct voltage equal to a level of a direct voltage component included in a signal output from the amplitude adjuster; and
a switch configured to switch whether or not to generate a synthesis signal, wherein
a first input signal is input to the adder/subtractor as the first signal, and
when the switch is switched to a side for generating the synthesis signal, a second input signal is subjected to adjustment of amplitude by the amplitude adjuster and then input to the adder/subtractor as the second signal, and when the switch is switched to a side for not generating the synthesis signal, a direct voltage generated by the direct voltage generator is input to the adder/subtractor as the second signal.

16. The signal synthesis circuit according to claim 15, wherein
the amplitude adjuster is configured using a differential amplifier circuit, and
when the switch is switched to a side for generating the synthesis signal, supply of power to the differential amplifier circuit is performed, and when the switch is switched to a side for not generating the synthesis signal, supply of power to the differential amplifier circuit is cut off.

17. The signal synthesis circuit according to claim 15, wherein
the direct voltage generator includes serially-connected resistor elements configured to generate a direct voltage equal to a level of a direct voltage component included in a signal output by the amplitude adjuster by dividing a power supply voltage.
